(19) United States
(12) Patent Application Publication
(10) Pub. No.: US 2021/0299855 A1
(43) Pub. Date: Sep. 30, 2021

(54) ROBOT AND ROBOT SYSTEM HAVING THE SAME

(71) Applicant: Kawasaki Jukogyo Kabushiki Kaisha, Kobe-shi (JP)

(72) Inventor: Takeshi HASHIMOTO, Kakogawa-shi (JP)

(73) Assignee: Kawasaki Jukogyo Kabushiki Kaisha, Kobe-shi (JP)

(21) Appl. No.: 17/343,807

(22) Filed: Jun. 10, 2021

Related U.S. Application Data
(63) Continuation of application No. PCT/JP2019/048849, filed on Dec. 13, 2019.

(30) Foreign Application Priority Data
Dec. 13, 2018 (JP) 2018-233383

(51) Int. Cl. B25J 9/00; B25J 15/04; B25J 9/04; B25J 15/00

(52) U.S. Cl. CPC B25J 9/0096; B25J 15/0019; B25J 9/043; B25J 15/04

(57) ABSTRACT

A robot includes a robotic arm having a wrist part, a coupling part at a tip end of the wrist part and configured to be coupled to a coupled part provided externally, and a robot controlling device having a memory and a processor configured to execute a program stored in the memory. The coupled part is attached to an installation stand where a workpiece is installed, and the installation stand has an adjustable installing width for the workpiece according to a type of the workpiece. When the processor executes the program stored in the memory, the coupled part is rotated while the coupling part is coupled to the coupled part to adjust the installing width.

### CROSS-REFERENCE TO RELATED APPLICATIONS

The present application is a bypass continuation of PCT Application No. PCT/JP2019/048849, filed Dec. 13, 2019, which claims priority to JP 2018-233383, filed on Dec. 13, 2018, the entire contents of each are incorporated herein by its reference.

### TECHNICAL FIELD

The present disclosure relates to a robot and a robot system having the robot.

### BACKGROUND ART

Conventionally, a demand for Factory Automation (FA) is increasing and robots to satisfy the demand are proposed. For example, a system may include a dual-arm robot placed between a workpiece stocker and a tray. The dual-arm robot transfers a workpiece stored in the workpiece stocker to the tray and positions the workpiece, while switching an arm part holding the workpiece between a right-arm part and a left-arm part.

### DESCRIPTION OF THE DISCLOSURE

Installation stands are placed at the same worksite as the robot, and have an adjustable installing width for a workpiece according to the type of the workpiece. However, conventional robots do not autonomously adjust the installing width. Therefore, generally, the installing width is adjusted directly by humans, or using a dedicated instrument operated by humans.

### SUMMARY OF THE DISCLOSURE

A robot according to the present disclosure is for use with an installation stand including an adjustable installing width for a workpiece and a coupled part attached to the installation stand where the workpiece is to be installed. The robot comprising a robotic arm including a wrist, and a coupling at an end of the wrist to be coupled to the coupled part. Further, there is circuitry configured to rotate the coupled part while the coupling is coupled to the coupled part to adjust the installing width.

### BRIEF DESCRIPTION OF DRAWINGS

FIG. 1 is a front view schematically illustrating the entire configuration of a robot system.

FIG. 2 is a block diagram illustrating the entire configuration of the robot system.

FIG. 3 is a perspective view schematically illustrating a part of a set-up device and a second end effector of the robot system.

FIGS. 4A and 4B are schematic views illustrating a situation in which a coupled part and a rotated object are rotated by the robot system, where FIG. 4A is a view before a coupling part is coupled to the coupled part, and FIG. 4B is a view where the coupling part is coupled to the coupled part, and the coupled part and the rotated object are rotated.

FIG. 5 is a flowchart illustrating one example of a procedure to rotate the coupled part and the rotated object in a first direction by a desired angle when a rotatable angle range of a rotary shaft is defined in advance, by the robot system.

FIG. 6 is a schematic view illustrating one example of a configuration of rotating the coupled part and the rotated object in the first direction by the desired angle when the rotatable angle range of the rotary shaft is defined in advance, according to Modification 1.

FIGS. 7A to 7C are schematic views illustrating a situation in which a first end effector is switched to the second end effector according to Modification 2, where FIG. 7A is a view before the switching, FIG. 7B is a view during the switching, and FIG. 7C is a view after the switching.

FIGS. 8A and 8B are schematic views of a substantial part illustrating Modification 3, where FIG. 8A is a view before the coupling part is coupled to the coupled part, and FIG. 8B is a view where the coupling part is coupled to the coupled part, and the coupled part and the rotated object are rotated.

FIGS. 9A and 9B are schematic views of a substantial part illustrating Modification 4, where FIG. 9A is a view before the coupling part is coupled to the coupled part, and FIG. 9B is a view where the coupling part is coupled to the coupled part, and the coupled part and the rotated object are rotated.

FIGS. 10A and 10B are schematic views of a substantial part illustrating Modification 5, where FIG. 10A is a view illustrating the entire configuration of a robot, and FIG. 10B is a view where the coupling part is coupled to the coupled part, and the coupled part and the rotated object are rotated.

### MODE FOR CARRYING OUT THE DISCLOSURE

Hereinafter, a robot and a robot system having the robot according to one embodiment of the present disclosure are described with reference to the accompanying drawings. Note that the present disclosure is not limited to this embodiment. Moreover, below, the same reference characters are given to the same or corresponding elements throughout the drawings to omit redundant description.

### Robot System 10

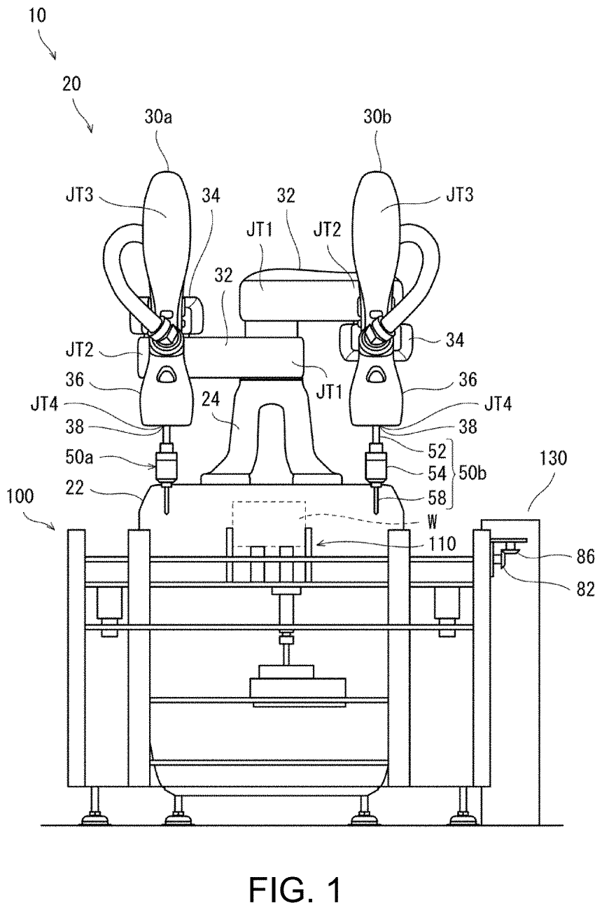

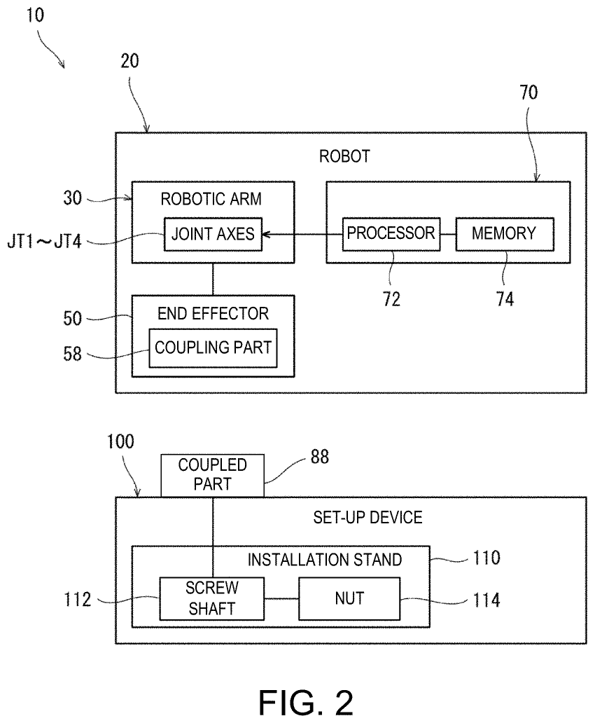

FIG. 1 is a front view schematically illustrating the entire configuration of the robot system according to this embodiment. FIG. 2 is a block diagram illustrating the entire configuration of the robot system. As illustrated in FIG. 1, a robot system 10 according to this embodiment is provided with a dual-arm robot 20 and a set-up device 100 placed adjacent to the robot 20. Then, the robot system 10 according to this embodiment is capable of changing tools (set-up) corresponding to a change in a type of a manufactured workpiece W (in this embodiment, a change in a width of the workpiece W), by causing the robot 20 to operate the set-up device 100.

### Robot 20

As illustrated in FIG. 1, the robot 20 according to this embodiment is provided with a pedestal 22, a first robotic arm 30a and a second robotic arm 30b supported by the pedestal 22 (hereinafter, they may be referred to as “a pair of robotic arms 30a and 30b”). Moreover, the robot 20 is further provided with a first end effector 50a attached to a tip end of the first robotic arm 30a, and a second end effector 50b attached to a tip end of the second robotic arm 30b. Then, the robot 20 further includes a robot controlling device 70 which controls operation of the first robotic arm 30a, the second robotic arm 30b, the first end effector 50a, and the second end effector 50b (see FIG. 2).

### Pair of Robotic Arms 30a and 30b

Each of the pair of robotic arms 30a and 30b is a horizontally articulated robotic arm supported by the pedestal 22. The pair of robotic arms 30a and 30b may move independently or may move interlocking with each other. Note that the second robotic arm 30b has a similar configuration as the first robotic arm 30a. Therefore, only the first robotic arm 30a is described, and a similar description for the second robotic arm 30b is not repeated.

The first robotic arm 30a has joint axes JT1 to JT4. Then, the first robotic arm 30a is provided with motors corresponding to the joint axes JT1 to JT4, which rotary drives the joints. The first robotic arm 30a has a first link 32, a second link 34, and a wrist 36 (a wrist part).

The first link 32 is coupled to a base shaft 24 fixed to an upper surface of the pedestal 22 via the rotary joint axis JT1 so as to be rotatable about a vertically extending axis defined to pass through an axial center of the base shaft 24. The second link 34 is coupled to a tip-end part of the first link 32 via the rotary joint axis JT2 so as to be rotatable about a vertically extending axis defined at the tip-end part of the first link 32.

The wrist 36 is coupled to a tip end of the second link 34 via the linear-motion joint axis JT3. The wrist 36 is ascendable and descendible with respect to the second link 34 by the linear-motion joint axis JT3. Moreover, the wrist 36 has a mechanical interface 38 at its tip end. The first end effector 50a is attached to the mechanical interface 38. The mechanical interface 38 is rotatable with respect to the wrist 36 about a vertically extending axis, by the rotary joint axis JT4 (a rotary shaft).

The axis on the base-end side of the first link 32 of the first robotic arm 30a is coaxial with the axis on the base-end side of the first link 32 of the second robotic arm 30b. Moreover, the first link 32 of the first robotic arm 30a and the first link 32 of the robotic arm 30b are provided having a height difference therebetween.

### First and Second End Effectors 50a and 50b

The first end effector 50a is attached to the mechanical interface 38 of the first robotic arm 30a (the tip end of the wrist part of the first robotic arm). The first end effector 50a is provided in order to perform a work to the workpiece W, which is provided separately from a coupled part 80 and an installation stand 110 (described later).

The second end effector 50b is attached to the mechanical interface 38 of the second robotic arm 30b (the tip end of the wrist part of the second robotic arm). The second end effector 50b has a shaft member 52 attached to the mechanical interface 38 at its base-end part, an enlarged part 54 provided to a tip-end part of the shaft member 52, and a coupling part 58 provided to a tip end of the enlarged part 54.

As illustrated in FIG. 1, the coupling part 58 is configured as a fitting male part which is fittable into the coupled part 88 (a fitting female part) described later. Note that at least one of the fitting male part and the fitting female part (described later) is formed with a rotation stopper. By the rotation stopper being provided in this manner, the coupled part 88 is rotatable integrally with the coupling part 58. Axes of the shaft member 52, the enlarged part 54, and the coupling part 58 are positioned coaxially.

### Robot Controlling Device 70

The robot controlling device 70 is, for example, built in the pedestal 22. As illustrated in FIG. 2, the robot controlling device 70 has a memory 72 (e.g., a memory), and a processor 74 (e.g., a CPU) which executes a program stored in the memory 72.

Further, the functionality of the elements disclosed herein may be implemented using circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality. Processors are considered processing circuitry or circuitry as they include transistors and other circuitry therein. The processor may be a programmed processor which executes a program stored in a memory. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

### Set-Up Device 100

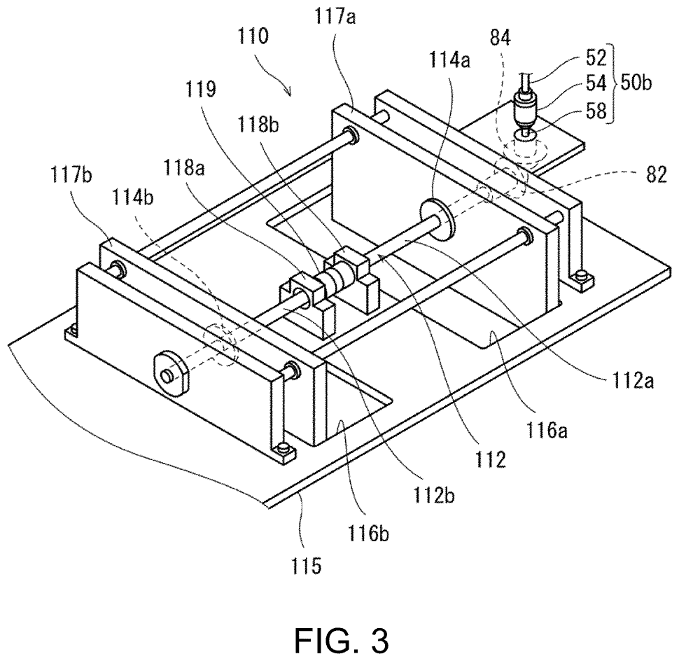

FIG. 3 is a perspective view schematically illustrating a part of the set-up device and the second end effector of the robot system according to this embodiment. As illustrated in FIG. 3, the set-up device 100 has the installation stand 110 where the workpiece W is installed. The installation stand 110 has an adjustable width for installation of the workpiece W according to the type of the workpiece.

In detail, the installation stand 110 has a screw (or bolt) shaft 112 (a rotated object) with a thread groove formed on its outer surface, and nuts 114a and 114b threadedly engaged with the screw shaft 112 so as to move on the screw shaft 112 in the axial direction. That is, the screw shaft 112 and the nuts 114a and 114b are what is called a “ball screw,” and a rotational motion of the screw shaft 112 can be converted into a linear motion of the nuts 114a and 114b.

Moreover, the installation stand 110 has a base plate 115, a guide plate 117a attached to the nut 114a such that a thickness direction of the guide plate 117a coincides with the axial direction of the screw shaft 112, and a guide plate 117b attached to the nut 114b such that a thickness direction of the guide plate 117b coincides with the axial direction of the screw shaft 112.

The guide plate 117a is inserted into a through-hole 116a in a rectangular shape, which is bored on the base plate 115. Then, the guide plate 117a moves in the axial direction of the screw shaft 112, inside the through-hole 116a bored on the base plate 115 accompanying with the movement of the nut 114a on the screw shaft 112 in the axial direction. Similarly, the guide plate 117b is inserted into a through-hole 116b in a rectangular shape, which is bored on the base plate 115. Then, the guide plate 117b moves in the axial direction of the screw shaft 112, inside the through-hole 116b bored on the base plate 115 accompanying with the movement of the nut 114b on the screw shaft 112 in the axial direction.

Bearings 118a and 118b are attached at an intermediate part of the screw shaft 112 in the axial direction so as to stand from the base plate 115. The screw shaft 112 has a first screw shaft 112a provided on a side of the nut 114a and the guide plate 117a, and rotatably supported by the bearing 118a, and a second screw shaft 112b provided on a side of the nut 114b and the guide plate 117b, and rotatably supported by the bearing 118b.

The first screw shaft 112a and the second screw shaft 112b are coupled to each other via a coupling 119 provided between the bearing 118a and the bearing 118b. Then, the second screw shaft 112b is formed on its outer surface with a thread groove in a direction different from that of the first screw shaft 112a.

According to this configuration, the rotation of the screw shaft 112 causes the nut 114b and the guide plate 117b to move in the direction opposite from the nut 114a and the guide plate 117a in the axial direction of the screw shaft 112. Then, a distance between the guide plate 117a and the guide plate 117b defines the installing width of the workpiece W. Note that a structural element or unit member used for installing the workpiece W may be provided between the guide plate 117a and the guide plate 117b. In such a case, the structural element or unit member, or a part of the structural element or unit member defines the installing width of the workpiece W.

### Coupled Part 80

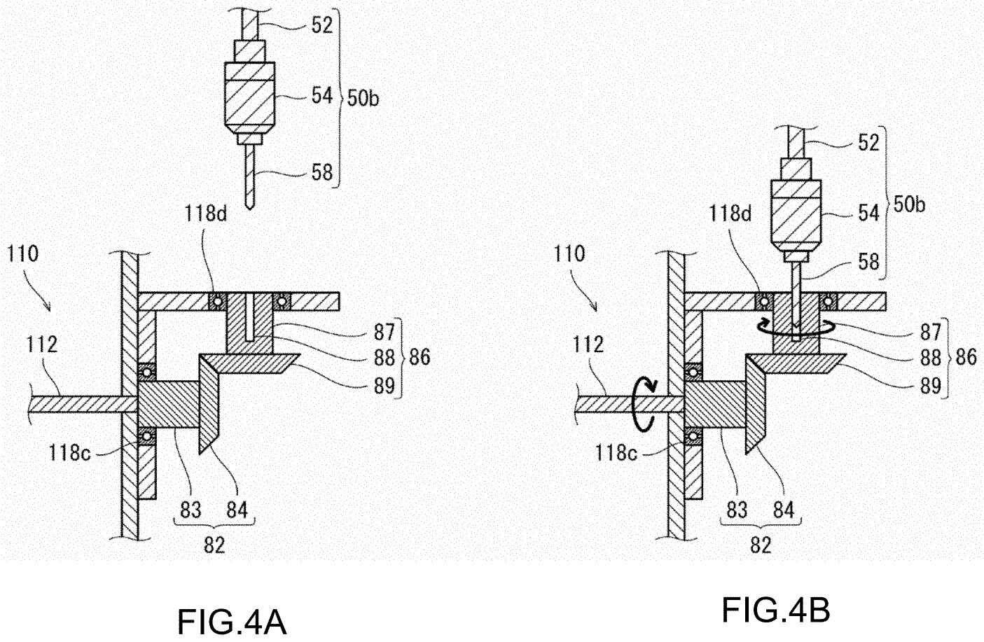

FIGS. 4A and 4B are schematic views illustrating a situation in which the coupled part and the rotated object are rotated by the robot system according to this embodiment, where FIG. 4A is a view before the coupling part is coupled to the coupled part, and FIG. 4B is a view where the coupled part and the rotated object are rotated by the coupling part being coupled to the coupled part. As illustrated in FIGS. 3, 4A and 4B, the robot system 10 according to this embodiment is further provided with a first bevel gear 82 and a second bevel gear 86 which mesh with each other.

The first bevel gear 82 has a shaft part 83 and a gear part 84 provided at a tip end of the shaft part 83. The first bevel gear 82 is attached at its base-end part (i.e., a base-end part of the shaft part 83) to a wall surface of the set-up device 100 via a bearing 118c, and disposed so that the shaft part 83 extends horizontally. Then, the first bevel gear 82 is attached at its base-end part (the base-end part of the shaft part 83) to an end part of the screw shaft 112 in the axial direction.

The second bevel gear 86 has a shaft part 87 and a gear part 89 provided at a tip end of the shaft part 87. The second bevel gear 86 is attached at its base-end part (i.e., a base-end part of the shaft part 87) to the wall surface of the set-up device 100 via a bearing 118d, and disposed so that the shaft part 87 extends vertically. Here, the base end of the shaft part 87 is located at the upper side, and the tip end of the shaft part 87 (and the gear part 89) is located at the lower side.

Then, the second bevel gear 86 is formed at its base end (i.e., the base end of the shaft part 87) with the coupled part 88. In this embodiment, the coupled part 88 is the fitting female part formed in the base end of the shaft part 87 of the second bevel gear 86. According to this configuration, in this embodiment, the coupled part 88 is attached to the screw shaft 112 (rotated object) provided to the installation stand 110, via the first and second bevel gears 82 and 86. Similar to this embodiment, the coupled part 88 may be couplable with the coupling part 58b of the second end effector 50b.

### Operation Mode of Robot 20

When the processor 74 executes the program stored in the memory 72, the robot 20 according to this embodiment rotates the joint axis JT4 (rotary shaft) of the second robotic arm 30b while coupling the coupling part 58 of the second end effector 50b to the coupled part 88 of the second bevel gear 86 so as to rotate the coupled part 88 and the screw shaft 112 (rotated object) on the installation stand 110, and thus, the installing width can be adjusted.

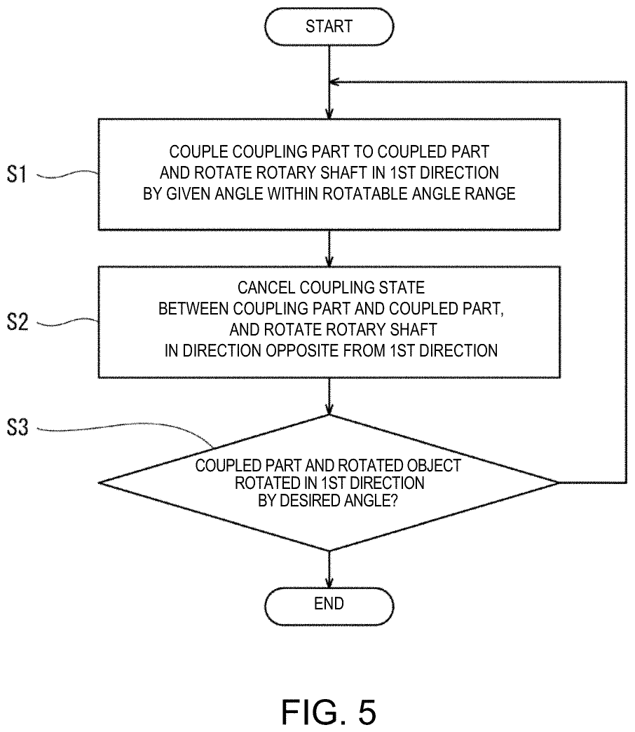

FIG. 5 is a flowchart illustrating one example of a procedure to rotate the coupled part and the rotated object in a first direction by a desired angle by the robot system according to this embodiment, when a rotatable angle range of the rotary shaft is defined in advance. Here, the rotatable angle ranges of the joint axes JT4 (rotary shafts) of the first and second robotic arms 30a and 30b are defined in advance, respectively. Therefore, wiring, piping, etc., built in the first and second robotic arms 30a and 30b can be prevented from being twisted and damaged.

As described above, when the rotatable angle range of the joint axis JT4 (rotary shaft) of the second robotic arm 30b is defined in advance, the robot 20 may carry out Steps S1 to S3 illustrated in FIG. 5 by the processor 74 executing the program stored in the memory 72.

First, the robot 20 couples the coupling part 58 to the coupled part 88, and then, rotates the joint axis JT4 (rotary shaft) in the first direction by a given angle within the rotatable angle range (Step S1 in FIG. 5).

Next, the robot 20 cancels the coupling state between the coupling part 58 and the coupled part 88, and then, rotates the joint axis JT4 (rotary shaft) in the direction opposite from the first direction (Step S2 in FIG. 5).

Then, the robot 20 repeats the series of operation (i.e., Steps S1 and S2) until the coupled part 88 and the screw shaft 112 (rotated object) are rotated in the first direction by the desired angle (Step S3 in FIG. 5).

### Effects

Conventionally, the installation stands adjustable of the installing width according to the type of the workpiece, are known. However, generally, the installing width of the conventional installation stand is adjusted directly by humans, or using the dedicated instrument operated by humans. However, the adjustment of the installing width in this manner may require time and effort. Particularly, in the latter case, time and effort may be required also to prepare and maintain the dedicated instrument.

On the other hand, the robot 20 according to this embodiment adjusts the installing width by rotating the coupled part 88 while coupling the coupling part 58 to the coupled part 88, and thus, neither manual control by a person nor a dedicated instrument is required. As a result, the robot 20 according to this embodiment the installing width is autonomously adjustable with a simple device configuration.

Moreover, in this embodiment, since the coupling part 58 can be coupled to the coupled part 88 by the fitting male part fitting into the fitting female part, the coupling part 58 and the coupled part 88 can be coupled to each other with the simple configuration.

Then, the robot 20 according to this embodiment rotates the joint axis JT4 (rotary shaft) provided to the robot 20 so as to rotate the coupled part 88 and the screw shaft 112 (rotated object) on the installation stand 110 attached to the coupled part 88. Therefore, the installing width can be autonomously adjusted with a further simple device configuration.

Moreover, in this embodiment, by performing Steps S1 to S3 in the flowchart of FIG. 5, the coupled part 88 and the screw shaft 112 (rotated object) can be securely rotated by the desired angle even when the rotatable angle range of the joint axis JT4 (rotary shaft) is defined in advance.

Moreover, in this embodiment, since the second end effector 50b can rotate the coupled part 88 and the screw shaft 112 (rotated object) while the first end effector 50a performs a work to the workpiece W provided separately from the coupled part 88 and the installation stand 110, the work can be performed efficiently.

Then, the robot system 10 according to this embodiment can achieve effects similar to those of the robot 20 as it is provided with the robot 20.

### Modifications

It is apparent for a person skilled in the art from the above description that many improvements and other embodiments of the present disclosure are possible. Therefore, the above description is to be interpreted only as illustration, and it is provided in order to teach a person skilled in the art the best mode for implementing the present disclosure. The details of the structures and/or the functions may be substantially changed, without departing from the spirit of the present disclosure.

### Modification 1

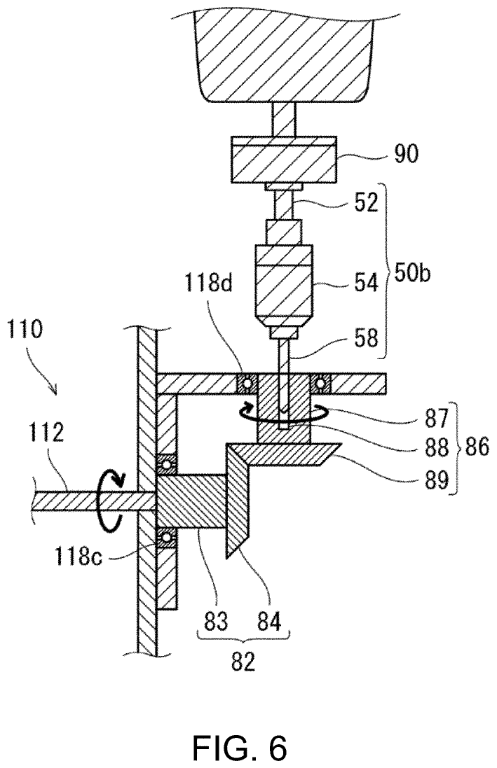

Modification 1 of the robot system of the embodiment described above is described with reference to FIG. 6. FIG. 6 is a schematic view illustrating one example of a configuration of rotating the coupled part and the rotated object in the first direction by the desired angle when the rotatable angle range of the rotary shaft is defined in advance, according to Modification 1 of the robot system of the embodiment. Note that the robot system according to this modification has a similar configuration to the robot system 10 of the embodiment, except for being provided with a rotary joint 90. Therefore, the same reference characters are given to the same components, and similar description is not repeated.

When the rotatable angle range of the joint axis JT4 (rotary shaft) of the second robotic arm 30b is defined in advance, the robot 20 may not perform Steps S1 to S3 illustrated in FIG. 5, but the rotary joint 90 may be attached to the tip end of the wrist 36 (the tip end of the wrist part) of the second robotic arm 30b in the mode illustrated in FIG. 6.

That is, as illustrated in FIG. 6, when the rotatable angle range of the joint axis JT4 (rotary shaft) of the second robotic arm 30b is defined in advance, the robot 20 is further provided with the rotary joint 90 between the tip end of the wrist 36 and the second end effector 50b (and the coupling part 88). Thus, when the processor 74 executes the program stored in the memory 72, the robot 20 can rotate the tip end of the wrist 36 beyond the rotatable angle range.

### Modification 2

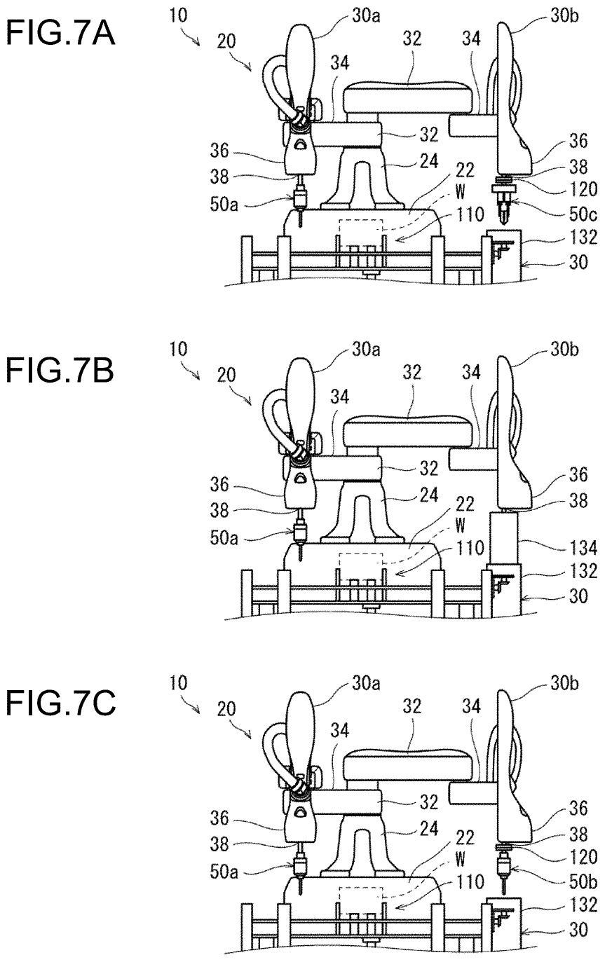

Modification 2 of the robot system of the embodiment is described with reference to FIGS. 7A to 7C. FIGS. 7A to 7C are schematic views illustrating a situation in which the first end effector is switched to the second end effector according to Modification 2 of the robot system of the embodiment, where FIG. 7A is a view before the switching, FIG. 7B is a view during the switching, and FIG. 7C is a view after the switching. Note that the robot system according to this modification has a similar configuration to the robot system 10 of the embodiment, except for that a tool changer 120 autonomously switches the end effector attached to the tip end of the second robotic arm 30b. Therefore, the same reference characters are given to the same components, and similar description is not repeated.

As illustrated in FIG. 7A, in an initial state of this modification, an end effector 50c is attached to the tip end of the wrist 36 (the tip end of the wrist part) of the second robotic arm 30b. The end effector 50c performs a work to the workpiece W provided separately from the coupled part 88 and the installation stand 110. As illustrated, the end effector 50c may have, for example, a gripping part which grips the workpiece W. The robot 20 according to this modification is further provided with the tool changer 120 between the tip end of the second robotic arm 30b (the tip end of the wrist part) and the end effector 50c.

In this modification, after the end effector 50c performs the work to the workpiece W, as illustrated in FIG. 7A, the end effector 50c is moved to above an end-effector switching device 130 provided adjacent to the robot 20 and the set-up device 100.

Then, as illustrated in FIGS. 7B and 7C, the end-effector switching device 130 sticks out a switching part 134 from an upper surface of a base part 132 so that the switching part 134 covers the end effector 50c, and switches the end effector 50c and the second end effector 50b at the tip end of the second robotic arm 30b (the tip end of the wrist part). Here, similar to the embodiment described above, the second end effector 50b has the coupling part 58 to be rotatable of the coupled part 88 and the screw shaft 112 (rotated object) on the installation stand 110.

The robot 20 according to this modification is provided with the tool changer 120, and thus capable of autonomously switching the end effector 50c (first end effector) to the second end effector 50b. Then, in this modification, even when an installation space is comparatively small, various works can be performed with the simple device configuration, by the tip end of the single second robotic arm 30b switching the end effector 50c and the second end effector 50b.

### Modification 3

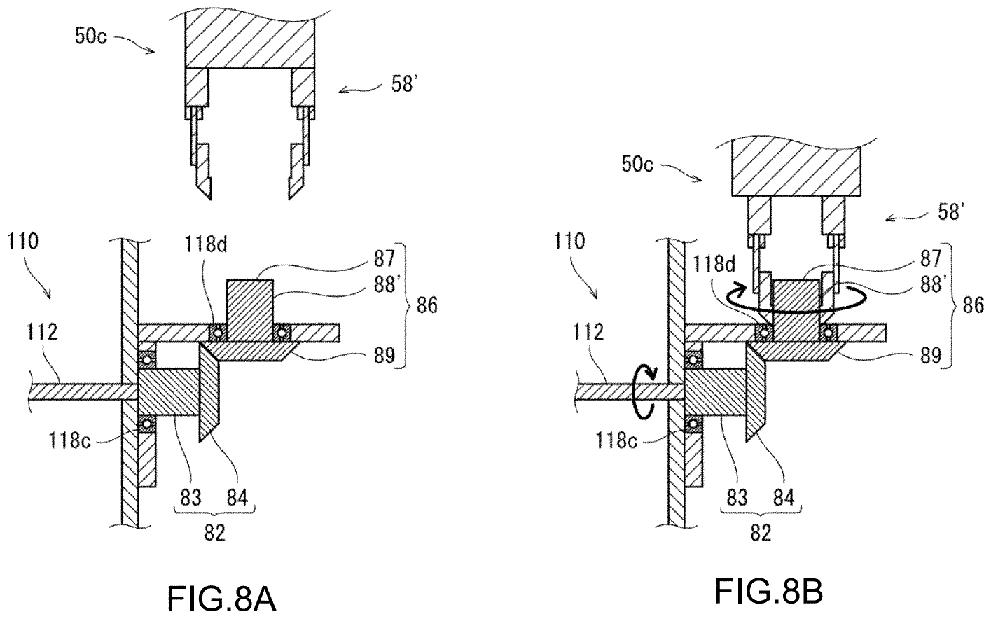

Modification 3 of the robot system of the embodiment is described with reference to FIGS. 8A and 8B. FIGS. 8A and 8B are schematic views of a substantial part illustrating Modification 3 of the robot system of the embodiment, where FIG. 8A is a view before the coupling part is coupled to the coupled part, and FIG. 8B is a view where the coupling part is coupled to the coupled part, and the coupled part and the rotated object are rotated. Note that the robot system according to this modification has a similar configuration to the robot system 10 of the embodiment, except for that the end effector 50c is attached to the tip end of the second robotic arm 30b, and for the configuration of the second bevel gear 86. Therefore, the same reference characters are given to the same components, and similar description is not repeated.

As illustrated in FIGS. 8A and 8B, the robot 20 according to this modification has the end effector 50c (a third end effector) which can perform the work to the workpiece W provided separately from the coupled part 88 and the installation stand 110. Then, in this modification, a coupled part 88′ is the shaft part 87 of the second bevel gear 86 described in the embodiment, and a coupling part 58′ provided to the end effector 50c is a gripping part (a holding part capable of holding) which can grip the coupled part 88′. That is, the coupling part 58′ is coupled to the coupled part 88′ by the gripping part gripping the shaft part 87 of the second bevel gear 86. Accordingly, the coupled part 88′ can be coupled to the end effector 50c or a part of the end effector 50c.

According to this configuration, the end effector 50c (third end effector) can perform the work to the workpiece W provided separately from the coupled part 88′ and the installation stand 110, as well as rotating the coupled part 88′ and the screw shaft 112 (rotated object). As a result, even when the installation space is comparatively small, various works can be performed with the simple device configuration.

### Modification 4

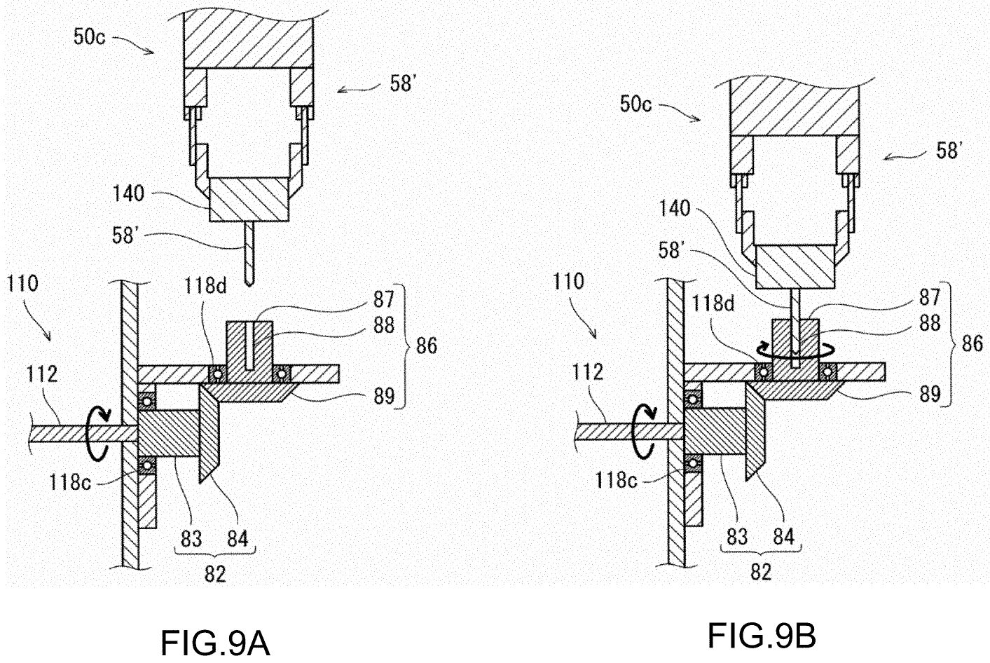

Modification 4 of the robot system of the embodiment is described with reference to FIGS. 9A and 9B. FIGS. 9A and 9B are schematic views of a substantial part illustrating Modification 4 of the robot system of the embodiment, where FIG. 9A is a view before the coupling part is coupled to the coupled part, and FIG. 9B is a view where the coupling part is coupled to the coupled part, and the coupled part and the rotated object are rotated. Note that the robot system according to this modification has a similar configuration to the robot system 10 of the above embodiment, except for that the end effector 50c is attached to the tip end of the second robotic arm 30b, and a rotary-driving device 140 is provided to be attached to the coupling part 58′. Therefore, the same reference characters are given to the same components, and similar description is not repeated.

The robot 20 according to this modification is provided with the rotary-driving device 140 attached to the coupling part 58′, and the end effector 50c (a fourth end effector) provided separately from the rotary-driving device 140, and attached to the tip end of the second robotic arm 30b (the tip end of the wrist part) to be holdable and releasable of the rotary-driving device 140.

As illustrated in FIGS. 9A and 9B, in this modification, when the processor 74 executes the program stored in the memory 72, the end effector 50c (fourth end effector) holds the rotary-driving device 140, and the rotary-driving device 140 is driven while the coupling part 58′ is coupled to the coupled part 88. Accordingly, the coupled part 88 and the screw shaft 112 (rotated object) on the installation stand 110 are rotated, thus the installing width being adjusted.

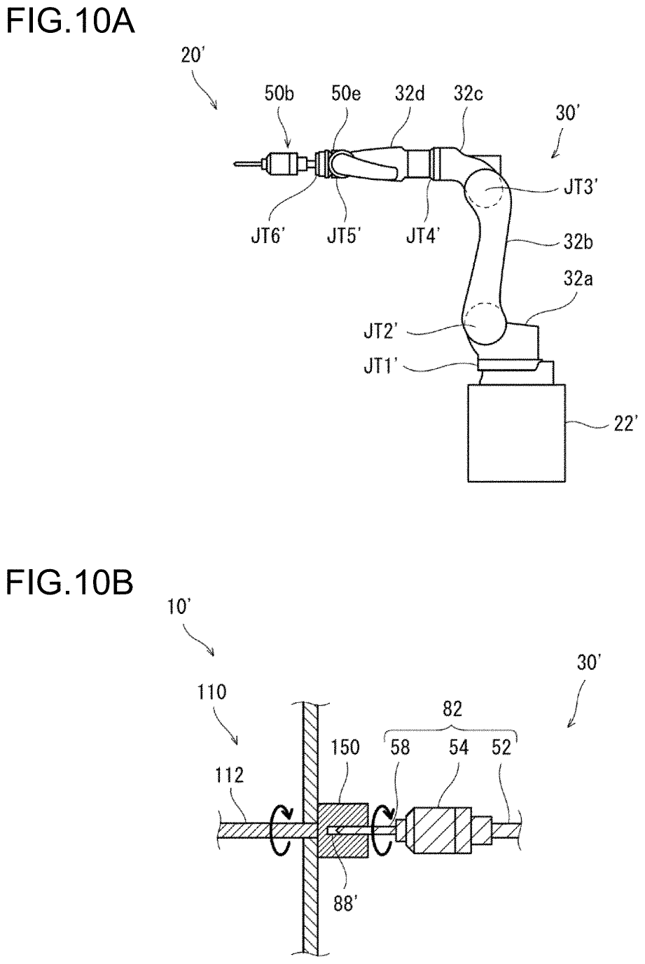

Modification 5 of the robot system of the embodiment is described with reference to FIGS. 10A and 10B. FIGS. 10A and 10B are schematic views of a substantial part illustrating Modification 5 of the robot system of the embodiment, where FIG. 10A is a view illustrating the entire configuration of a robot, and FIG. 10B is a view where the coupling part is coupled to the coupled part, and the coupled part and the rotated object are rotated.

In the embodiment and Modifications 1 to 4, the robot 20 has the horizontally articulated robotic arms supported by the pedestal 22. On the other hand, a robot 20′ according to this modification has a vertically articulated robotic arm.

In detail, the robot 20′ according to this modification is provided with a pedestal 22′, a robotic arm 30′ coupled at its base end to the pedestal 22′, the second end effector 50b attached to a tip-end part of the robotic arm 30′, and a robot controlling device 50′.

The robotic arm 30′ of this modification has six joint axes JT1′ to JT6′, and five links 32a to 32e sequentially coupled to each other by these joint axes. The joint axis JT1′ couples the pedestal 22′ to a base-end part of the link 32a so as to be swivelable about a vertically extending axis. The joint axis JT2′ couples a tip-end part of the link 32a to a base-end part of the link 32b so as to be pivotable about a horizontally extending axis. The third joint axis JT3′ couples a tip-end part of the link 32b to a base-end part of the link 32c so as to be pivotable about a horizontally extending axis.

The joint axis JT4′ couples a tip-end part of the link 32c to a base-end part of the link 32d so as to be rotatable about an axis extending in a longitudinal direction of the link 32c. The fifth joint axis JT5′ couples a tip-end part of the link 32d to a base-end part of the link 32e so as to be pivotable about an axis extending orthogonal to a longitudinal direction of the link 32d. The joint axis JT6 (rotary shaft) rotates a tip end of a wrist part of the robotic arm 30′ (and the second end effector 50b attached to the wrist part). Since a configuration of the second end effector 50b according to this modification is the same as that of the second end effector 50b of the embodiment described above, description thereof is not repeated.

As illustrated in FIG. 9B, since the robot 20′ according to this modification has the vertically articulated robotic arm, it can attach a rectangular parallelepiped object 150 to the screw shaft 112 (rotated object) provided to the installation stand 110, and the coupled part 88′ can be configured as the fitting female part formed so as to extend horizontally from a side surface of the rectangular parallelepiped object 150. Therefore, in this modification, since the first bevel gear 82 and the second bevel gear 86 are not necessary to the embodiment and Modifications 1 to 3, the device configuration can be simple in this respect.

Although in the embodiment the coupling part 58 is configured as the fitting male part, and the coupled part 88 is configured as the fitting female part, it is not limited to this. The coupling part 58 may be configured as the fitting female part, and the coupled part 88 may be configured as the fitting male part.

Although in the embodiment and modifications the robotic arm is configured as the dual-arm horizontally articulated type, or a vertically articulated type, it is not limited to this. For example, the robotic arm may be a single-arm horizontally articulated type. Alternatively, the robotic arm may be configured as a polar coordinate type, a cylindrical coordinate type, a Cartesian coordinate type, or other types.

Although in the embodiment and modifications the installation stand 110 is a part of the set-up device 100, it is not limited to this. The installation stand 110 may be another device or a part of the other device.

One exemplary purpose of the present disclosure is to provide a robot and a robot system having the robot, capable of autonomously adjusting a workpiece-installing width of an installation stand, of which the installing width is adjustable according to a type of a workpiece, with a simple device configuration.

According to an aspect of the disclosure, since the installing width is adjusted according to the type of the workpiece by rotating the coupled part while the coupling part is coupled to the coupled part, it becomes possible to adjust the installing width autonomously with a simple device configuration.

One of the coupling part and the coupled part may be configured to be a fitting female part, and the other of the coupling part and the coupled part may be configured to be a fitting male part fittable into the fitting female part. The coupling part may be coupled to the coupled part by the fitting female part being fitted onto the fitting male part.

According to this configuration, the coupling part and the coupled part can be coupled with a simple configuration.

For example, the coupling part may be configured to be a holding part holdable of the coupled part, and the holding part may be coupled to the coupled part by holding the coupled part.

The robot may further include an end effector attached to a tip end of the robotic arm. The end effector may include a first end effector configured to perform a work to a workpiece provided separately from the coupled part and the installation stand, and a second end effector having the coupling part to rotate the coupled part and a rotated object.

According to this configuration, the first end effector and the second end effector can perform different works from each other, and thus, various works can be performed.

The robot may further include a tool changer provided between the tip end of the wrist part and the end effector so as to autonomously switch the end effector between the first end effector and the second end effector.

According to this configuration, since the first end effector and the second end effector can be switched autonomously by the tip end of the single robot arm, even when an installation space is comparatively small, various works can be performed with the simple device configuration,

The robot may further include an end effector attached to a tip end of the robotic arm. The end effector may be configured to be a third end effector configured to perform a work to a workpiece provided separately from the coupled part and the installation stand. The coupling part may be configured to be the third end effector or a part of the third end effector. The coupled part may have a structure couplable to the third end effector or the part of the third end effector.

According to this configuration, since the third end effector can perform the work to the workpiece provided separately from the coupled part and the installation stand, as well as rotating the coupled part and the rotated object, even when the installation space is comparatively small, various works can be performed with the simple device configuration.

For example, the robotic arm may further include a rotary shaft configured to rotate the tip end of the wrist part. The coupled part may be attached to a rotated object provided to the installation stand, and the installation stand may be adjustable of the installing width by the rotated object being rotated. When the processor executes the program stored in the memory, the coupled part and the rotated object on the installation stand may be rotated by the rotary shaft being rotated while the coupling part is coupled to the coupled part, to adjust the installing width.

According to this configuration, since the rotary shaft provided to the robot is rotated to rotate the coupled part and the rotated object on the installation stand, to which the coupled part is attached, the installing width can be adjusted with a further simple device configuration.

A rotatable angle range of the rotary shaft may be defined in advance. When the processor executes the program stored in the memory, a series of operation in which, after the coupling part is coupled to the coupled part, and the rotary shaft is rotated in a first direction by a given angle within the rotatable angle range, the coupling state between the coupling part and the coupled part is canceled, and the rotary shaft is rotated in a direction opposite from the first direction, may be repeated until the coupled part and the rotated object are rotated in the first direction by a desired angle.

According to this configuration, even when the rotatable angle range of the rotary shaft is defined in advance, the coupled part and the rotated object can be rotated certainly by the desired angle.

A rotatable angle range of the rotary shaft may be defined in advance. The robot may further include a rotary joint provided between the tip end of the wrist part and the coupling part, and the tip end of the wrist part may be rotated beyond the rotatable angle range when the processor executes the program stored in the memory.

According to this configuration, even when the rotatable angle range of the rotary shaft is defined in advance, the coupled part and the rotated object can be rotated certainly by the desired angle.

In order to solve the problem, a robot system according to the present disclosure includes the robot of any one of the robots described above, and the coupled part and the installation stand provided outside the robot.

The robot may further include a rotary-driving device attached to the coupling part, and a fourth end effector provided separately from the rotary-driving device and attached to the tip end of the robotic arm to be holdable and releasable of the rotary-driving device. The coupled part may be attached to a rotated object provided to the installation stand, and the installation stand may be adjustable of the installing width by the rotated object being rotated. When the processor executes the program stored in the memory, the coupled part and the rotated object on the installation stand may be rotated, by the fourth end effector holding the rotary-driving device and by the rotary-driving device being driven while the coupling part is coupled to the coupled part, to adjust the installing width.

According to this configuration, since any of the robots described above is provided, it becomes possible to autonomously adjust the installing width of the installation stand, which is adjustable of the installing width according to the type of the workpiece, with a simple device configuration.

For example, the installation stand may be a set-up device, or a part of the set-up device.

According to the present disclosure, a robot and a robot system having the robot can be provided, which are capable of autonomously adjusting a workpiece-installing width of an installation stand, of which the installing width is adjustable according to a type of a workpiece, with a simple device configuration.

### DESCRIPTION OF REFERENCE CHARACTERS

10 Robot System
20 Robot
22 Pedestal
24 Base Shaft
30 Robotic Arm
32 First Link
34 Second Link
36 Wrist
38 Mechanical Interface
50 End Effector
52 Shaft Member
54 Enlarged Part
58 Coupling Part
70 Robot Controlling Device
72 Memory
74 Processor
82 First Bevel Gear
83 Shaft Part
84 Gear Part
86 Second Bevel Gear
87 Shaft Part
88 Coupled Part
89 Gear Part
90 Rotary Joint
100 Set-up Device
110 Installation Stand
112 Screw Shaft
112a First Part
112b Second Part
114 Nut
115 Base Plate
116 Through-hold
117 Guide Plate
118 Bearing
119 Coupling
120 Tool Changer
130 End-effector Switching Device
132 Base Part
134 Switching Part
140 Rotary-driving Device
150 Rectangular Parallelepiped Object
JT Joint Axis
W Workpiece

1. A robot for use with an installation stand including an adjustable installing width for a workpiece and a coupled part attached to the installation stand where the workpiece is to be installed, the robot comprising:
a robotic arm including a wrist;
a coupling at an end of the wrist to be coupled to the coupled part; and
circuitry configured to rotate the coupled part while the coupling is coupled to the coupled part to adjust the installing width.

2. The robot of claim 1, wherein:
one of the coupling and the coupled part is a fitting female part, and the other of the coupling and the coupled part is a fitting male part fittable into the fitting female part, and
the coupling is coupled to the coupled part by the fitting female part being fitted onto the fitting male part.

3. The robot of claim 1, wherein the coupling is a holding part to hold the coupled part, the holding part being coupled to the coupled part by holding the coupled part.

4. The robot of claim 1, further comprising:
an end effector attached to an end of the robotic arm, the end effector including a first end effector to perform a work on the workpiece which is separate from the coupled part and the installation stand, and a second end effector including having the coupling to rotate the coupled part and a rotated object.

5. The robot of claim 4, further comprising:
a tool changer between the end of the wrist and the end effector so as to autonomously switch the end effector between the first end effector and the second end effector.

6. The robot of claim 1, further comprising:
an end effector attached to an end of the robotic arm, the end effector is to perform a work on the workpiece separate from the coupled part and the installation stand,
wherein the coupling is the end effector or a part of the end effector, and
wherein the coupled part has a structure couplable to the end effector or the part of the end effector.

7. The robot of claim 1, wherein the robotic arm further includes a rotary shaft to rotate the end of the wrist,
wherein the coupled part is attached to a rotated object at the installation stand, the installing width of the installation stand being adjustable of the installing width by the rotated object being rotated, and
wherein when the circuitry is further configured to adjust the installing width by rotating the coupled part and the rotated object on the installation stand by the rotary shaft being rotated while the coupling is coupled to the coupled part.

8. The robot of claim 7, wherein:
a rotatable angle range of the rotary shaft is preset, and
the circuitry is further configured to execute a series of operation in which, after the coupling is coupled to the coupled part, and the rotary shaft is rotated in a first direction by a given angle within the rotatable angle range, a coupling state between the coupling and the coupled part is canceled, and the rotary shaft is rotated in a direction opposite from the first direction, is repeated until the coupled part and the rotated object are rotated in the first direction by a desired angle.

9. The robot of claim 7, wherein:
a rotatable angle range of the rotary shaft is preset, and
the robot further comprises a rotary joint between the end of the wrist and the coupling, and
the circuitry is further configured to rotate the end of the wrist beyond the rotatable angle range.

10. The robot of claim 1, further comprising:
a rotary-driving device attached to the coupling; and
an end effector separate from the rotary-driving device and attached to the end of the robotic arm to be holdable and releasable of the rotary-driving device,
wherein the coupled part is attached to a rotated object at the installation stand, the installation stand being adjustable of the installing width by the rotated object being rotated, and
wherein the circuitry is further configured to rotate the coupled part and the rotated object on the installation stand by the end effector holding the rotary-driving device and by the rotary-driving device being driven while the coupling is coupled to the coupled part, to adjust the installing width.

11. A robot system, comprising:
the robot of claim 1; and
the coupled part and the installation stand which are outside of the robot.

12. The robot system of claim 11, wherein the installation stand is a set-up device, or a part of the set-up device.

13. The robot of claim 1, wherein:
the coupling is external to the robot.

14. The robot of claim 1, wherein:
the circuitry include a processor to execute a program stored in a memory.

15. A robot for use with an installation stand including an adjustable installing width for a workpiece and a coupled part attached to the installation stand where the workpiece is to be installed, the robot comprising:
a robotic arm including a wrist;
a coupling at an end of the wrist to be coupled to the coupled part; and
means for rotating the coupled part while the coupling is coupled to the coupled part to adjust the installing width.

16. The robot of claim 15, wherein:
one of the coupling and the coupled part is a fitting female part, and the other of the coupling and the coupled part is a fitting male part fittable into the fitting female part, and
the coupling is coupled to the coupled part by the fitting female part being fitted onto the fitting male part.

17. The robot of claim 15, wherein the coupling is a holding part to hold the coupled part, the holding part being coupled to the coupled part by holding the coupled part.

18. The robot of claim 15, further comprising:
an end effector attached to an end of the robotic arm, the end effector including a first end effector to perform a work on the workpiece which is separate from the coupled part and the installation stand, and a second end effector including having the coupling to rotate the coupled part and a rotated object.

19. The robot of claim 18, further comprising:
a tool changer between the end of the wrist and the end effector so as to autonomously switch the end effector between the first end effector and the second end effector.

20. The robot of claim 15, further comprising:
an end effector attached to an end of the robotic arm, the end effector is to perform a work on the workpiece separate from the coupled part and the installation stand,
wherein the coupling is the end effector or a part of the end effector, and
wherein the coupled part has a structure couplable to the end effector or the part of the end effector.
